(19) United States
(12) Patent Application Publication
(10) Pub. No.: US 2017/0184296 A1
(43) Pub. Date: Jun. 29, 2017

(54) THERMO-OPTICAL ENCLOSURE FOR LED LIGHTING APPLICATIONS

(71) Applicant: PHILIPS LIGHTING HOLDING B.V., EINDHOVEN (NL)

(72) Inventors: Simon Eme KADIJK, EINDHOVEN (NL); Vincent Stefan David GIELEN, EINDHOVEN (NL); Abraham Rudolf BALKENENDE, EINDHOVEN (NL); Jordy Bernard Margreth SCHOENMAEKERS, EINDHOVEN (NL)

(21) Appl. No.: 15/313,381

(22) PCT Filed: May 14, 2015
(86) PCT No.: PCT/EP2015/060714

§ 371 Date: Nov. 22, 2016

(30) Foreign Application Priority Data
May 22, 2014 (EP) 14169385.3

(51) Int. Cl. F21V 29/51; F21V 3/02; F21V 29/58; F21K 9/232; F21K 9/237

(52) U.S. Cl. CPC F21V 29/51; F21K 9/232; F21K 9/237; F21V 29/58; F21V 3/02; F21Y 2115/10

(57) ABSTRACT

The invention provides a lamp (1) comprising (i) a solid state light source (10) and a first envelope (100) at least partially enclosing the light source (10), thereby forming a first cavity (150) hosting said solid state light source (10), wherein at least part of the first envelope (100) is transmissive for visible light (11) generated by the solid state light source (10); and (ii) a second envelope (200) at least partially enclosing the first envelope (100), wherein the first envelope (100) and the second envelope (200) provide a second cavity (250) at least partially enclosing the light source (10), wherein at least part of the second envelope (200) is transmissive for visible light (11) generated by the light source (10) and transmitted through the first envelope (100) into the second cavity (250), wherein the second cavity (250) is configured as a heat pipe (251).

### FIELD OF THE INVENTION

The invention relates to a lamp, and to an envelope assembly and a power assembly that may be part of such lamp. The invention further relates to a method for providing such lamp.

### BACKGROUND OF THE INVENTION

The issue of heat management of LEDs in lamps is known in the art. US2013/0162139, for instance, describes a LED bulb including a top optical section, a middle heat dissipation section, and a bottom electrical section. The optical section includes a light source and a light guider. The light source further includes a substrate and at least one LED arranged on the substrate. The heat dissipation section includes a sleeve at a rear of the optical section and a chamber. The sleeve has a tube portion and a sealed end with a heat absorbing surface thermally contacting the substrate. A porous wick structure is arranged on the outer sidewall of the tube portion and contains working fluid therein. The chamber has an annular configuration defined between an inner side surface of an LED bulb shell and an outer side surface of the sleeve. The electrical section includes a threaded cap arranged at a bottom portion of the LED bulb, and a circuit board received in the sleeve.

US2010/271836 describes an LED lamp having a heat dissipating means as well as a headlamp (to be mounted e.g. to the front of a vehicle such as e.g. a car or a truck) comprising said LED lamp. Embodiments of US2010/271836 also relate to a method for dissipating heat from an LED lamp.

DE102012211279 describes a semiconductor light-emitting device having at least one semiconductor light source and at least one light-transmitting cover for the at least one semiconductor light source, wherein the cover is a heat pipe and introduced as a hollow body with at least one therein cooling means filled cavity.

US2013/113358 describes LED based lamps and bulbs that comprise an elevating element to arrange. LEDs above the lamp or bulb base. The elevating element can at least partially comprise a thermally conductive material. A heat sink structure is included, with the elevating element thermally coupled to the heat sink structure. A diffuser can be arranged in relation to the LEDs so at least some light from the LEDs passes through the diffuser and is dispersed into the desired emission pattern. Some lamps and bulbs utilize a heat pipe for the elevating elements, with heat from the LEDs conducting through the heat pipe to the heat sink structure where it can dissipate in the ambient. The LED lamps can include other features to aid in thermal management and to produce the desired emission pattern, such as internal optically transmissive and thermally conductive materials, and heat sinks with different heat fin arrangements.

WO2004100213 describes a light source comprising a light engine, a base a power conversion circuit and an enclosure. The light engine comprises at least one LED disposed on a platform. The platform is adapted to directly mate with the base which a standard incandescent bulb light base. Phosphor receives the light generated by the at least one LED and converts it to visible light. The enclosure has a shape of a standard incandescent lamp.

US2011/074296 describes an LED illumination apparatus. The apparatus includes a body having a lower portion adapted for coupling to a power socket and an upper portion provided with a power source module accommodating chamber. A heat-dissipating module includes a funnel-shaped hollow case disposed at a top end of the upper portion and filled with a coolant fluid, wherein the hollow case has a small diameter open end adjacent to the body and a large diameter open end remote from the body. A light source module includes amounting substrate disposed at the small diameter open end, an LED mounted on the mounting substrate, and a power source module disposed within the power source module accommodating chamber in a manner electrically connected to and supplying working power to the LED.

DE102011004718 describes a method involving inserting an inner piston wall into an outer piston wall so that a hollow space is formed between the inner piston wall and the outer piston wall. A heat conducting filling e.g. helium, is introduced into the hollow space by a pump stem, which is attached at the outer piston wall. A pump hole is formed in an edge region of an edge of the inner piston wall, where the edge is laterally projected over an insertion region of the inner piston wall. The hollow space is closed by sealed covering of the pump hole by another edge region.

### SUMMARY OF THE INVENTION

LED based solutions are less than 100% efficient. The heat that is generated during operation generally leads to temperatures in the application that may deteriorate the system efficacy and may limit the lifetime of the LEDs and other components. In order to transfer heat to the ambient, LED devices generally use a heat sink. In most LED applications the heat sink and the light emitting area are two separate elements. The size of the heat sink is in general smaller than the total lamp enclosure, limiting the heat transfer to the ambient and thus the thermal performance.

Another option, distributing the LEDs over a 3D curved outer enclosure, leads to complex and expensive solutions, while using flat surfaces leads to deviating shapes of the lamp or luminaire. Other LED based solutions may include LEDs placed inside a transparent or translucent container and a special gas, like Helium, is used to enhance the internal heat transfer from the LED source(s) to the enclosure. The inside heat transfer from LED source towards this enclosure via convection or conduction through the gas is not very effective. Hence, also the above options that have been investigated suffer from a poor thermal performance.

The prior art systems thus seem to suffer from thermal management problems which may only be solved (partially) at the cost of optical properties. Vice versa, when optimizing optical properties, thermal management is a problem. Further, assembly of the prior art lamps is regularly not straightforward.

Hence, it is an aspect of the invention to provide an alternative lamp, which preferably further at least partly obviates one or more of above-described drawbacks.

In this invention, the full outer enclosure may be used for heat transfer to the ambient, since the full enclosure may be at a substantially uniform (high) temperature dictated by the internal vapor chamber temperature (see below). At the same time the vapor chamber has an optical function and is forming the mechanical enclosure of LEDs and electronics. The vapor chamber is a hermetically sealed chamber especially containing a single pure fluid and vapor chamber compatible materials only. This ensures the substantial isothermal condition in the vapor chamber and the maximum thermal performance. It may be manufactured as a separate part, allowing the full use of glass or ceramics processing like heating in an oven (e.g. to 400° C.) to remove (organic) contamination, vacuum pumping, and filling with a pure fluid and subsequent hermetic sealing by glass processing. All common fluids that are used for operation around room temperature, like water, methanol, ethanol, acetone or ammonia are compatible with e.g. a glass or ceramic container. Similarly the wick materials (see below) can be chosen to be compatible with the working fluid. Further, the wick layer may relatively easily be applied, such as via a pump stem or through coating of subassemblies prior to assembling the vapor chamber. Further, also two pump stems may optionally be applied, a first pump stem for introduction of the coating liquid, and a second pump stem for escape of gas, and option some (superfluous) coating liquid.

After coating, the pump stem(s) may be closed (including optionally a partial removal of (one or more of) the pump stem(s)).

Hence, the invention provides an embodiment wherein the heat pipe wick layer is obtainable by a method comprising a wet chemical deposition coating process, especially via a pump stem functionally coupled with the second cavity. However, the coating may also be provided, via a wet chemical deposition coating process, before assembling the envelope assembly (see also below). Hence, the pump stem may be physically connected to the first envelope or the second envelope; however, the pump stem is especially functionally coupled to the second cavity (which is provided by the first envelope and the second envelope).

By covering at least part of the inside walls of the container (herein also indicated as second cavity or vapor chamber) with a light transmissive wick, all orientations of the lamp or luminaire can be used with similar thermal performance, as the liquid phase can return to the heat source from any point by the capillary function.

Especially, the invention provides the use of a hermetically sealed transparent or translucent container as a vapor chamber in which especially no foreign elements are introduced and which can be manufactured as a separate part using e.g. high temperature glass or ceramics processing, which allows assembling in the lamp under normal ambient temperature conditions. The LEDs and the electronics are placed at the outside of the container (second cavity), as no foreign elements, except for the wick and working fluid (see below), are desired in the second cavity.

The same glass or ceramics (or other material) container is an optical element of the LED lamp or luminaire to distribute the light all around, or directional, and the same glass or ceramics (or other material) container is a mechanical enclosure of LEDs and driver.

A derivative solution is to deliberately add a controlled amount non-condensable gas to the vapor chamber in order to guarantee a minimum internal pressure in the container and thereby reduce the stresses on the vapor chamber container that arise from the difference between ambient en internal pressure. In this way, a balance can be between thermal performance and mechanical robustness of the system. Preferably, the container is shaped in such a way that the non-condensable gases are not trapped in a section of the container but can mix with the evaporating fluid.

Hence, in a first aspect the invention provides a lamp, the lamp comprising: (i) a solid state light source (“light source”) and a first envelope at least partially enclosing the solid state light source, thereby forming a first cavity hosting said solid state light source, wherein at least part of the first envelope is transmissive for visible light (“light”) generated by the solid state light source; and (ii) a second envelope at least partially enclosing the first envelope, wherein the first envelope and the second envelope provide a (closed) second cavity at least partially enclosing the solid state light source, wherein at least part of the second envelope is transmissive for visible light generated by the solid state light source and transmitted through the first envelope into the second cavity, wherein the (closed) second cavity is configured as a heat pipe comprising a heat pipe working fluid (“working fluid” or “fluid”) and comprising over at least part of an internal surface (upstream face) of said second cavity a heat pipe wick layer (“wick layer” or “wick” or “wick structure”), wherein at least a part of the internal surface of said second cavity formed by the first envelope comprises said heat pipe wick layer, and wherein in a specific embodiment the heat pipe wick layer comprises a coating, such as a sol-gel coating. The coating is especially applied via a wet chemical deposition coating process, such as a sol-gel coating process. The term “wet chemical deposition” or “wet chemical deposition coating process” is herein used in a very broad sense, especially implying that a solution is used containing a precursor to the final coating composition. This solution is applied to a substrate surface, especially with coating techniques known in the art, of which some are also mentioned herein. Upon chemical conversion and/or annealing this solution is converted into a solid phase thereby providing the final coating. Particles can be added in addition. The solid phase essentially connects the particles to the substrate surface and to each other.

The present solution allows a transfer of heat to the full outer surface of the enclosure (i.e. the external surface of the second envelope), which offers the maximum possible thermal performance. Further, the invention allows the integration of the optical, mechanical and thermal function in the enclosure (or envelope). The invention allows embodiments with a e.g. fully glass or ceramics based vapor chamber, transparent or translucent, with no other components in it except for the wick and the working fluid to enable a reliable long time operation. The solid state light sources are not subjected to undesired gas conditions (within the second cavity or heat pipe), and the heat pipe provides an efficient heat management. With a (small but) sufficient amount of the working fluid that in liquid condition can be contained in the wick, the wick allows the liquid to be transported back towards the heat source (especially the outer surface of the first envelope). Especially, all orientations of the lamp are effective for cooling, for instance with a wick covering all inside walls of the container or heat pipe. The present lamp allows ambient temperature assembly of the parts of the lamp or luminaire, not causing damage to vulnerable parts. The present invention thus especially provides a thermo-optical enclosure for LED lighting applications. Further, the present lamp can be made in various embodiments, such as with a “GLS (general lighting service) look and feel”. As all three functions, (i) thermal management, (ii) light distribution and (iii) mechanical/safety enclosure are taken up by the thermo-optical enclosure (i.e. the envelope assembly), a minimal use of metals and polymers is possible. Further, the wick layer may be applied in a relatively easy way, such as with a sol-gel coating liquid or other liquid, which may include particulate material, which may provide a wick layer with (the desired) porosity.

The term “solid state light source” is herein also indicated as “light source”. The term “light source” may also relate to a plurality of light sources, such as 2-20 solid state light sources, though in specific embodiments much more light sources may be applied, such as 10-1000. Hence, the term LED may also refer to a plurality of LEDs. The light source may comprise a solid state LED light source, such as a LED or laser diode. Solid-state lighting (SSL) refers to a type of lighting that uses semiconductor light-emitting diodes (LEDs), organic light-emitting diodes (OLED), or polymer light-emitting diodes (PLED) as sources of illumination. When more than one light source is applied, optionally these may be controlled independently, or subsets of light source may be controlled independently. The light source is configured to generate visible light, either directly or in combination with a light converter especially integrated in the solid state light source, such as in a dome on a LED die or in a luminescent layer (such as a foil) on or close to a LED die.

The light source is arranged on a support. This support may be comprised by the power assembly. In an embodiment, also the light source is comprised by the power assembly (see further below). This support is at least partly arranged in the first cavity formed by the first envelope. The first envelope at least partially surrounds the light source. The support may include a material that has a good thermal conductivity. For instance, the support may include a metal layer or ceramic layer. Especially, the support is in physical contact with part of the internal surface of the first envelope. In this way, heat from the solid state light source may be transferred via the support to the first envelope. Then, via the heat pipe the thermal energy is dissipated at the external surface of the second envelope. Optionally, a thermal interface material, especially a thermally conductive paste, may be used to enhance the heat transfer from support to the first envelope. Especially, such thermal interface material may have a thermal conductivity of at least 0.5 W/(m·K), such as at least 1.0 W/(m·K), like at least 2.0 W/(m·K).

The first envelope especially is at least partially transmissive, i.e. part of the first envelope is transmissive for the light of the light source. For instance, the first envelope may comprise transmissive glass, quartz, a transmissive ceramic, or a transmissive polymer.

Hence, the material of at least part of the first envelope may be of a transmissive material. Especially, the entire first envelope is transmissive for visible light. Hence, the material of the first envelope may be of a transmissive material. Likewise, the second envelope especially is at least partially transmissive, i.e. part of the second envelope is transmissive for the light of the light source. For instance, the second envelope may comprise transmissive glass, quartz, a transmissive ceramic, or a transmissive polymer. Hence, the material of at least part of the second envelope may be of a transmissive material. Especially, the entire second envelope is transmissive for visible light. Hence, the material of the second envelope may be of a transmissive material. The term “transmissive” may especially refer to transparent or translucent, and refers to the transmissivity for (visible) light.

Especially, the materials of the first envelope and second envelope are substantially the same. This facilitates the integration of the envelopes into an envelope assembly that at least partly encloses the light source and that provides the second cavity as heat pipe.

Especially, the material of the first envelope and/or the material of the second envelope may comprise one or more materials selected from the group consisting of a transmissive organic material support, such as selected from the group consisting of PE (polyethylene), PP (polypropylene), PEN (polyethylene napthalate), PC (polycarbonate), polymethylacrylate (PMA), polymethylmethacrylate (PMMA) (Plexiglas or Perspex), cellulose acetate butyrate (CAB), silicone, polyvinylchloride (PVC), polyethylene terephthalate (PET), (PETG) (glycol modified polyethylene terephthalate), PDMS (polydimethylsiloxane), and COC (cyclo olefin copolymer). However, in another embodiment the material of the first envelope and/or the material of the second envelope may comprise an inorganic material. Preferred inorganic materials are selected from the group consisting of glasses, (fused) quartz, transmissive ceramic materials, and silicones. Also hybrid materials, comprising both inorganic and organic parts may be applied. Especially preferred are PMMA, transparent PC, or glass as material for the material of the first envelope and/or the material of the second envelope. Hence, one or more of the first envelope and the second envelope comprise a material independently selected from the group consisting of glass, a translucent ceramic, and a light transmissive polymer. Especially, the first envelope and the second envelope comprise the same material.

Especially, the material of the first envelope and/or the material of the second envelope have a light transmission in the range of 50-100%, especially in the range of 70-100%, for light generated by the lighting source and having a wavelength selected from the visible wavelength range. In this way, the first envelope and/or the second envelope are transmissive for visible light from the light source. Herein, the term “visible light” especially relates to light having a wavelength selected from the range of 380-780 nm. The transmission or light permeability can be determined by providing light at a specific wavelength with a first intensity to the material and relating the intensity of the light at that wavelength measured after transmission through the material, to the first intensity of the light provided at that specific wavelength to the material (see also E-208 and E-406 of the CRC Handbook of Chemistry and Physics, 69th edition, 1088-1989).

As indicated above, the first envelope at least partially encloses the light source. In general, the first envelope will include a cylindrical part, having a diameter which is constant over at least part of the length of the first envelope, and having an opening at one side. The power assembly may at least partly be arranged into the first envelope. The entire first envelope may have a uniform diameter. Optionally, the diameter of the first envelope may vary over its length.

The light source especially comprises a light emitting surface, relative to the light emitting surface, the first envelope may enclose the light source over an angle larger than 180°, such as e.g. 270° or larger. Hence, a distance from the light source to the first opening at a first end (“one side”) of the first envelope may be larger than a distance between the light source and a second end (“opposite side”) of the first envelope, wherein the first end and the second end substantially define the length of the first envelope. Such configuration improves distribution of the light and distribution of heat. Hence, in this way the lamp may be more efficient.

The first envelope will have an opening at one side. Optionally, there may be a substantially equally sized opening at an opposite side. This may especially be the case in a cylindrical first envelope. In other embodiments, the diameter at an opposite side may decrease, and the first envelope may be closed at the opposite side. This may be an entirely closed opposite side. Optionally, there is an opening, in general substantially smaller than the opening at the one side, which can be used for evacuating and/or introducing a fluid. This opening may be connected with a pump stem. Note that in the present invention, especially either the first envelope or the second envelope comprises such opening for a pump stem. Hence, in embodiments the first envelope may include at least one larger opening, through which the light source may be introduced, and optionally a smaller opening for a pump stem. In case a pump stem associated with the first envelope is applied, this pump stem is especially arranged in the cavity formed by the first envelope. Hence, at least part of the pump stem and the solid state light source may in the final lamp share the first cavity.

The first and the second envelope are assembled together to form the second cavity. The combination of the two envelopes is herein also indicated as envelope assembly. The second envelope includes a second cavity, which is configured to host at least part of the first envelope. The two envelopes are connected to each other, e.g. by melting glass, gluing polymer, a ceramic solder, etc., to provide a closed second cavity, except for a smaller opening in one or optionally more of the first envelope and the second envelope for a pump stem. Herein, the invention is described with reference to a single first envelope and a single second envelope. Optionally, a plurality of first envelopes may be used.

The second envelope is arranged such, that it at least partially encloses the first envelope, whereby it also at least partially surrounds the first cavity. This configuration is such, that in the ready lamp, the second envelope also partially encloses the light source. Nevertheless, the solid state light source is not inside the second cavity; the second cavity may enclose or surround at least part of the first cavity, but the light source is configured inside the first cavity, with the second cavity at least partially enclosing the first envelope. In this way, the light source is not subjected to less desired conditions (such as the working fluid). The second cavity is especially substantially hollow, and substantially only filled with the working fluid.

Hence, the lamp is configured to provide light, from the light source, that is transmitted through the first envelope and is subsequently transmitted through the second envelope. Therefore, the first envelope at least partially encloses the solid state light source, thereby forming a first cavity hosting said solid state light source, wherein at least part of the first envelope is transmissive for visible light (“light”) generated by the solid state light source, and the second envelope at least partially encloses the first envelope, wherein the first envelope and the second envelope provide a closed second cavity at least partially enclosing the solid state light source, wherein also at least part of the second envelope is transmissive for visible light generated by the solid state light source and transmitted through the first envelope into the second cavity.

The envelope assembly can have different shapes. In embodiments, the second envelope may have the shape of a bulb lamp (“bulb”), of a candle lamp (“candle”), or of a tubular lamp (“tube”). For instance, the second envelope may have the shape of a TL lamp (TL), a SON lamp, a SOX lamp, a HPL lamp, etc. The present invention thus also allows retro type of lamps. Hence, with the present invention all kind of lamp shapes are possible, like (light) bulb, incandescent lamps, gas discharge lamps, reflector lamps, TL lamps, etc., such as e.g. A, G, PS, and similar shapes (ANSI), with e.g. E26 medium screw basis, etc.

The invention provides in a further aspect the envelope assembly per se, i.e. an envelope assembly comprising: (i) a first envelope, configured to enclose at least partially a solid state light source (and providing a first cavity hosting said solid state light source), wherein at least part of the first envelope is transmissive for visible light; and (ii) a second envelope at least partially enclosing the first envelope, wherein the first envelope and the second envelope provide a (closed) second cavity, the closed cavity configured to enclose at least partially said solid state light source, wherein at least part of the second envelope is transmissive for visible light, wherein the (closed) second cavity is configured as a heat pipe comprising a heat pipe working fluid and comprising over at least part of an internal surface of said second cavity a heat pipe wick layer, wherein at least a part of the internal surface of said second cavity formed by the first envelope comprises said heat pipe wick layer.

In specific embodiments, either the first envelope, or the second envelope, and optionally both, may include an opening for a pump stem. In the ready lamp, the pump stem is closed, whereby a closed second cavity or heat pipe is obtained. In case the pump stem is associated with the first envelope, the pump stem may at least partially penetrate into the first cavity. In case the pump stem is associated with the second envelope, at least part of the pump stem may protrude from the external surface from the second envelope.

In yet a further aspect, the invention also provides a method comprising providing the second cavity by connecting the first envelope and the second envelope, wherein at least one of these envelopes comprise a second cavity opening for a pump stem.

The envelope assembly is used as optical element, as light source light escapes from the second envelope as lamp light, and the envelope assembly is used as heat pipe. For these reasons, the envelopes are at least partially transmissive for visible light generate by the light source, and the second cavity includes a wick layer and a working fluid.

A heat pipe or heat pin is a heat-transfer device that combines the principles of both thermal conductivity and phase transition to efficiently manage the transfer of heat between two solid interfaces. At the hot interface of a heat pipe a liquid in contact with a thermally conductive solid surface turns into a vapor by absorbing heat from that surface. The vapor then travels along the heat pipe to the cold interface and condenses back into a liquid—releasing the latent heat. The liquid then returns to the hot interface through capillary action, centrifugal force, or gravity, and the cycle repeats. Due to the very high heat transfer coefficients for boiling and condensation, heat pipes are highly efficient thermal conductors.

For the heat pipe to transfer heat, it especially contains a liquid and its vapor at saturated vapor pressure (gas phase) (at least at operation conditions). The liquid vaporizes and travels to a condenser spot (the internal surface of the second envelope), where it is cooled and turned back to a liquid. In a standard heat pipe, the condensed liquid is returned to the evaporator (external surface of the first envelope) using a wick structure exerting a capillary action on the liquid phase of the working fluid. The full strength of two-phase cooling solutions is used in the generally known concepts of the heat pipe and the vapor chamber. In such structures there is essentially a single fluid contained in a hermetically sealed container. Usually a second element is a porous capillary structure (the wick) to lead the liquid phase back to the heat source location. Cleanliness, purity and compatibility of all materials inside the heat pipe or vapor chamber are relevant, as known to the person skilled in the art, in order to prevent gases to develop that quickly deteriorate the performance. Such heat pipes and vapor chambers are especially configured to operate at the saturation pressure of the fluid and have an (almost) uniform temperature inside the container as condensation or evaporation takes place whenever the temperature deviates from the internal temperature.

Hence, the heat pipe comprises over at least part of its internal surface the wick or wick layer. The internal surface of the heat pipe comprises at least part of the external surface (downstream surface) of the first envelope and at least part of the internal surface (upstream surface) of the second envelope. The wick layer may cover the whole internal surface or only part thereof. When the wick layer covers the entire internal surface of the heat pipe, the wick layer should also be transmissive. This can e.g. be achieved by using a thin layer, by using material that is transmissive for light, etc.

Therefore, especially the heat pipe wick layer is transmissive for visible light generated by the solid state light source unit. In an embodiment, the heat pipe wick layer comprises particles, such as spherical particles, especially these (spherical) particles having dimensions, such as diameters, selected from the range of 1-150 μm, like 5-120 μm. The (spherical) particles may especially comprise a particle material transmissive for visible light generated by the solid date light source unit. For instance, glass particles or glass beads may be used, especially hollow particles or beads may be used. By choosing the right dimensions, such as the afore-mentioned diameters, a porous layer is obtained. As is known to the person skilled in the art, the wick layer will be a porous layer, configured to allow transport of the fluid (in the liquid state).

Further, the heat pipe wick layer may comprise a binder material. In an embodiment, the binder material may optionally have an index of refraction differing in value less than 15% of an index of refraction of the particle material.

The particles (or beads) may be hollow particles, filled with a fluid such as air or water, etc. Especially, the particles may be filled with a fluid particle filling material having an index of refraction (also) differing in value less than 15% of an index of refraction of the particle material. However, the particles may also be massive particles (i.e. not hollow). The particles (or beads) may be spherical, but may also have other shapes. Also combinations of different shaped particles may be applied. Instead of particles (or beads), one may also apply a glass fiber layer, such as a glass fiber sleeve.

The wick layer may be obtained in different ways. For instance, the wick layer may be provided to part of the external surface of the first envelope and/or part of the internal surface of the second envelope before assembling the envelope assembly. However, as the assembly of the envelope assembly may include increased temperatures, this might affect the heat pipe wick layer. Therefore, in another embodiment, the wick layer may be introduced (via the pump stem) via the (smaller) opening in the second cavity or envelope assembly that is available in the first (and/) or second envelop (i.e. after assembly of the envelope assembly). The heat pipe wick layer may especially be obtainable by one or more of flow coating and dip coating. However, other methods known to the person skilled in the art may also be applied. Alternatively or additionally, the heat pipe wick layer may especially be obtainable by spray coating or dip coating. Flow coating may especially be used when the heat pipe wick layer is (at least partially) applied via a pump stem.

The porosity of the wick layer is especially at least 30% (see also below), such as at least 35%, even more especially at least 40%, such as e.g. up to 90%, such as up to 80%.

When using a coating method to provide the wick layer, the coating may be a single layer coating process or a multi-layer coating process. In the latter embodiment, optionally first a binder layer may be applied, and then the particles may be applied. Alternatively, these may be provided in a single stage (such as in a single layer coating), or in a plurality of subsequent single layer coatings. The term coating may herein also refer to a multi-layer coating.

The wick layer is especially applied to at least part of the external surface of the first envelope, as the heat generating light source is included in the first cavity. Hence, at least a part of the internal surface of said second cavity formed by the first envelope comprises said heat pipe wick layer. Further, the wick layer on the first envelope especially extends over at least part of the internal surface of the second envelope. Therefore, in an embodiment also at least a part of the internal surface of said second cavity formed by the second envelope comprises said heat pipe wick layer. The wick layer may be a coating or a sleeve, etc. When the wick layer covers only part of the internal surface of the second cavity, this will especially the part of the internal surface provided by the external surface of the first envelope, especially that part of the first envelope which may e.g. be closest to the support (for the light sources) at the other side of the envelope (i.e. in the first cavity).

As mentioned above, in some embodiments the entire internal surface of the heat pipe comprises the wick layer. The extend of the wick layer may depend upon the type of the lamp and its intended use (see also below).

The envelope assembly or heat pipe does not only include the wick layer, but also a working fluid. Especially, the heat pipe working fluid comprises one or more of H₂O, methanol, ethanol, i-propanol (iso propanol), 1-propanol, butanol (such as 1-butanol), acetone, and (optionally) ammonia, etc. Especially, the working fluid comprises a fluid that has a boiling point selected from the range of −50-150° C. (at atmospheric pressure). Especially, the working fluid comprises a fluid that has a boiling point at atmospheric pressure above the expected working temperature range of the heat pipe, especially boiling point in the range of 60-130° C. Further, during operation of the lamp, fluid will condense at the internal surface of the second envelope, and be transported to the hot spots at the first envelope, close to the light source, and then vaporize again, followed by transport of the fluid as gas to the second envelope again, etc. In an embodiment, the working fluid is selected of one or more of ammonia, pentane, acetone, methanol, ethanol, propanol, heptane and water, especially one or more of water, ethanol and methanol, even more especially one or more of water and ethanol. In yet a further embodiment, the working fluid comprises one or more of H₂O, methanol, ethanol, propanol (such as one or more of 1-propanol and i-propanol), butanol (such as one or more of 1-butanol, 2-butanol, etc.), acetone, pentane, heptane, and (optionally) ammonia.

The working fluid may comprise a substantially pure fluid, such as less than 10 vol. %, especially less than 5 vol. %, even more especially less than 1 vol. % of the total fluid being other fluids (such as a non-condensable fluid; see below) than the main fluid. For instance, one may include (liquid) water in the heat pipe and remove air by evacuation, which may provide the substantially pure working fluid, such as pure water. However, optionally one may (deliberately) include a non-condensable fluid, such as air, and/or or especially a low density gas like He or Ne. By choosing the fluid and/or by tuning the fluid composition an acceptable internal pressure close to the atmospheric pressure may be obtained at the operating temperature of the heat pipe, and also a minimum internal pressure at room temperature, i.e. when the lamp is in off-state. In an embodiment, a non-condensable gas may be available having a partial pressure (of the non-condensable gas) at room temperature selected from the range of 0-100 kPa, like, below 50 kPa. The total pressure of the fluid in the heat pipe at room temperature may be 1 bar (atmospheric pressure) or even higher, but is especially lower, such as 0.5 bar or lower, such as in the range of 0.1-0.5 bar. Especially when using ceramic envelopes, a pressure larger than 1 bar at room temperature may be possible.

As indicated above, the first envelope of the second envelope may include a pump stem. After the desired conditions, including gas composition (including a substantially pure fluid) (and gas pressure), is obtained, the pump stem can be closed. This can be done by methods know in the art, like melting, soldering, sealing, etc. Assuming the pump stem to be part of the first envelop, this may imply that a small piece of pump stem may extend from the first cavity. For this reason, the power assembly (see also below) may include an assembly cavity to host this pump stem (remains). This may not be necessary when the pump stem is (was) associated with the second envelope. In this situation, there is no gas contact between the first cavity and the second cavity.

In yet a further aspect, the invention also provides a method comprising: (i) providing a sol-gel composition to the second cavity via the second cavity opening, the sol-gel composition comprising particles, especially spherical particles, even more especially having dimensions, such as diameters, selected from the range of 1-150 μm, and wherein the (spherical) particles comprise a particle material transmissive for visible light, followed by formation of a solid wick layer, such as by drying; (ii) providing a heat pipe working fluid to the second cavity; and (iii) closing the second cavity.

In yet a another aspect, the invention also provides a method comprising: (i) providing a sol-gel composition to the second cavity via the second cavity opening, the sol-gel composition comprising particles, wherein the (spherical) particles comprise a particle material transmissive for visible light, followed by drying (or another way to provide a solid layer); (ii) providing a heat pipe working fluid to the second cavity; and (iii) closing the second cavity.

In yet a further aspect, the invention also provides method a comprising: (i) providing wick layer, such as a porous glass fiber-based sleeve, to at least part of the external surface of the first envelope, and optionally to at least part of the internal surface of the second envelope; (ii) providing (i.e. assembling) the envelope assembly; (iii) providing a heat pipe working fluid to the second cavity; and (iv) closing the second cavity. Also this method may include the use of a sol-gel composition.

When coating, a coating composition may be applied comprising a liquid. This liquid may especially comprise one or more of water, methanol, ethanol, isopropanol, butanol, butylacetate, or another suitable solvent, including a combination of two or more of the afore-mentioned.

The heat pipe is especially configured to transport the heat from the light source to the second envelop. Hereby, the heat has to be transferred through the first envelope. Hence, especially, the light source may be in thermal contact with the first envelope. This may by physical contact and/or a heat transfer element. In yet another embodiment, the lamp may comprise a solid state light source support in thermal contact with the first envelope. This support may include a PCB (printed circuit board). The support may be in physical contact with the first envelope. In a specific embodiment, the solid state light source support includes a heat sink, and wherein the heat sink is in thermal contact with the first envelope, especially in physical contact with the first envelope. Especially, the solid state light source support includes a heat sink, wherein the heat sink comprises a ceramic heat pipe. In such embodiment, the lamp includes two heat pipes. As indicated above, optionally also a thermally conductive paste to improve thermal contact between the support and the first envelope.

In general, the first cavity will be closed with a closure. Such closure may especially comprise a component configured to transfer electrical power from an external source to the solid state light source. This may include one or more of electrical connection means (wires), a control unit, a transformer, etc. In a specific embodiment, the power assembly is an assembly also including the light source (i.e. including embodiments wherein the term “light source” refers to a plurality of light sources”). Further, as indicated above, the first envelope may include a (remains of a) pump stem. Hence, especially, the power assembly includes a cavity for the pump stem. Hence, in an embodiment the lamp further comprises a power assembly, in a specific embodiment comprising said solid state light source, a component configured to transfer electrical power from an external source to the solid state light source, and especially also an end cap (with electrical connections), wherein the first cavity at least partly hosts the power assembly, and wherein in a specific embodiment the power assembly optionally comprises an assembly cavity for hosting a pump stem (which is (or in fact was) functionally coupled with the second cavity).

In yet a further aspect, the invention also provides the power assembly per se, i.e. a power assembly comprising a solid state light source, a component configured to transfer electrical power from an external source to the solid state light source, and an end cap with electrical connections, wherein the power assembly further optionally comprises an assembly cavity for hosting a pump stem. In an alternative variant, the invention also provides the power assembly per se, i.e. a power assembly comprising a component configured to transfer electrical power from an external source to a solid state light source, and an end cap (with electrical connections), wherein the power assembly further optionally comprises an assembly cavity for hosting a pump stem. This variant can be used when the light source(s) have already been arranged in the first cavity before closing the first cavity (see also below). In yet an alternative variant, the invention provides the power assembly per se comprising a solid state light source, a component configured to transfer electrical power from an external source to the solid state light source, and an end cap (with electrical connections). This latter variant may be applied for envelope assemblies wherein the second envelope is (was) functionally coupled to a pump stem.

The power assembly can thus be arranged at least partly into the first cavity. The power assembly and first cavity (or first envelope) are secured to each other, such as with a glue, by form fit, etc. Another option to secure the power assembly to the envelope assembly may be by using a clamping construction, optionally in combination with friction. In this way the items can be clamped to each other, and friction may add to the prevention of declamping the items.

Above, some general shapes of the first envelope have been discussed. In specific embodiments, the first cavity (i.e. especially the first envelope) comprises a tubular or helix light sources structure hosting a plurality of solid state light sources. For instance, a strip with a plurality of solid state light sources may be arranged in the first cavity. With such embodiments, optionally the light sources may be arranged in the first cavity before assembling the envelope assembly. However, in general, the light sources may be arranged in the first cavity after assembling the envelope assembly.

In yet another embodiment, the lamp includes at least two subsets of solid state light sources arranged within the first cavity and in embodiments facing each other, wherein the first cavity further includes an optical element, such as refractive optics, configured to direct the visible light of the solid state light source of the at least two subsets in a direction of the second envelope. Especially, in such embodiment the first envelope may substantially have a cylindrical shape. Further, optionally one (or more) of the subsets may be arranged in the first cavity before the second envelop is arranged to the first envelop. Optionally, the two or more subsets may be controlled individually (with a (remote) controller).

In yet a further aspect, the invention also provides a method for providing the lamp as defined herein, comprising arranging the power assembly as defined herein at least partly in the first cavity of the envelope assembly as defined herein, and securing the power assembly and the envelope assembly to each other.

As indicated above, especially the envelope assembly is obtainable by a method comprising: (i) providing the second cavity by connecting the first envelope and the second envelope, wherein at least one of these envelopes comprise a second cavity opening for a pump stem; (ii) providing a sol-gel composition to the second cavity via the second cavity opening, the sol-gel composition comprising (spherical) particles having dimensions, such as diameters, selected from the range of 1-150 μm, and wherein the spherical particles comprise a particle material transmissive for visible light, followed by drying; (iii) providing a heat pipe working fluid to the second cavity; and (iv) closing the second cavity. Optionally, wick layer formation may also include a chemical reaction, such as polymerization or cross-linking.

However, as indicated above, also other options are possible, such as providing the wick layer to one or more of at least part of the first envelope (especially the external surface) and/or at least part of the second envelope (especially the internal surface), especially at least to at least part of the first envelope, before assembling the envelopes into the envelope assembly.

Hence, in an embodiment the invention provides a method for providing the lamp as defined herein, the method comprising arranging the power assembly as defined herein at least partly in the first cavity of the envelope assembly as defined herein and securing the power assembly and the envelope assembly to each other, wherein the envelope assembly is obtainable by a method comprising: (i) providing the second cavity by connecting the first envelope and the second envelope, (ii) providing a heat pipe working fluid to the second cavity; and (iii) closing the second cavity, wherein the heat pipe wick layer is provided to the one or more of at least part of the external surface of the first envelope and at least part of the internal surface of the second envelope before assembly of the envelope assembly or after assembly of the envelope assembly.

The heat pipe wick layer may be provided before assembly especially by providing a coating composition to (at least part of) the external surface or downstream surface of the first envelope. Thereafter, the first envelope and second envelope may be assembled into the envelope assembly. After assembly of the envelope, a coating composition to (at least part of) the external surface or downstream surface of the first envelope may be applied via the second cavity opening, such as via a pump stem. After application of the coating composition, to provide said wick layer, and after introduction of the working fluid, the second envelope may be closed by closing the second cavity opening, such as by closing a pump stem, like by e.g. melting or providing a plug.

Hence, the invention also provides a method for providing such envelope assembly, as indicated herein, such as indicated above. When applying the wick layer to one or more of the envelopes, especially at least part of the external surface of the first envelope, this may be easier controllable, then when applying the wick layer to the envelope assembly. In the latter instance, a coating liquid especially has to be applied through the pump stem. Providing the wick layer beforehand may provide an easier control of the wick layer formation and also an easier control when only part of one of the envelopes may have to be provided with the wick layer. For instance, it may not be (always) necessary to provide a wick layer to the end of the first envelope opposite of the first envelope of first cavity opening.

As indicated above, especially at least part of the external surface of the first envelope comprises the wick layer, as this envelope may include the most hot spot(s). Optionally, also part of the internal surface of the second envelope may comprise the wick layer. Hence the phrase, “at least a part of the internal surface of said second cavity formed by the first envelope comprises said heat pipe wick layer” includes embodiments wherein only the first envelope includes at least partially said wick layer and embodiments where also the second envelope (i.e. its internal surface) may at least partially comprise said wick layer.

In an embodiment, the wick layer comprises (i) particles selected from the group consisting of solid glass spheres, hollow glass spheres, chopped fibers, milled fibers, alumina particles, titania particles, silica particles, etc., and (ii) a binder selected from the group consisting of TEOS (tetra-ethyl-orthosilane) (based sol gel), MTMS (methyltrimethoxysilane) (based sol gel), TEOTi (tetra-ethyl-orthotitanate), and an aluminum phosphate AlPOx precursor, such as mono-aluminum phosphate (MAP). Hence, the coating may e.g. be a TiO₂ base sol gel coating or a SiO₂ based sol-gel coating, or an aluminum phosphate based coating, or a combination thereof. The afore-mentioned particles, such as alumina particles, titania particles, silica particles are especially transmissive for visible light, and are further especially stable under the operation conditions of the lamp. The weight averaged mean particle sizes may especially be in the range of 1-150 μm, like 5-120 μm.

Optionally, a pre-coating may be applied to at least part of the internal surface of the second cavity.

The porosity of the heat pipe wick layer is especially in an embodiment in the range of 50-75%, such as in the range of 55-70%. Good results (in terms of stability, crack formation, layer thickness, etc.) were obtained with these porosities.

The terms “upstream” and “downstream” relate to an arrangement of items or features relative to the propagation of the light from a light generating means (here the especially the first light source), wherein relative to a first position within a beam of light from the light generating means, a second position in the beam of light closer to the light generating means is “upstream”, and a third position within the beam of light further away from the light generating means is “downstream”.

The lighting device may be part of or may be applied in e.g. office lighting systems, household application systems, shop lighting systems, home lighting systems, accent lighting systems, spot lighting systems, theater lighting systems, fiber-optics application systems, projection systems, self-lit display systems, pixelated display systems, segmented display systems, warning sign systems, medical lighting application systems, indicator sign systems, decorative lighting systems, portable systems, automotive applications, green house lighting systems, horticulture lighting, or LCD backlighting.

Especially, fields of application are: Consumer Lamps: Candles, bulbs, spot lights, TLED; Professional lamps (especially street light lamps); Consumer Luminaires (Indoor); Professional Luminaires (Indoor spots, outdoor luminaries); Street lights: integrated Lamp-Luminaire designs; Special lighting: extreme environments (e.g. pigsties with ammonia levels), or underwater lighting (glass is watertight and can be easily coated to prevent organic growth); etc.

The term “substantially” herein, such as in “substantially all light” or in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention further applies to a device comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Furthermore, some of the features can form the basis for one or more divisional applications.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1A-1G schematically depict some aspects of the lamp;

FIGS. 2A-2B schematically depict some possible embodiments of the lamp;

FIGS. 3A-3D schematically depict some variants of the lamp.

The drawings are not necessarily on scale.

### DETAILED DESCRIPTION OF THE EMBODIMENTS

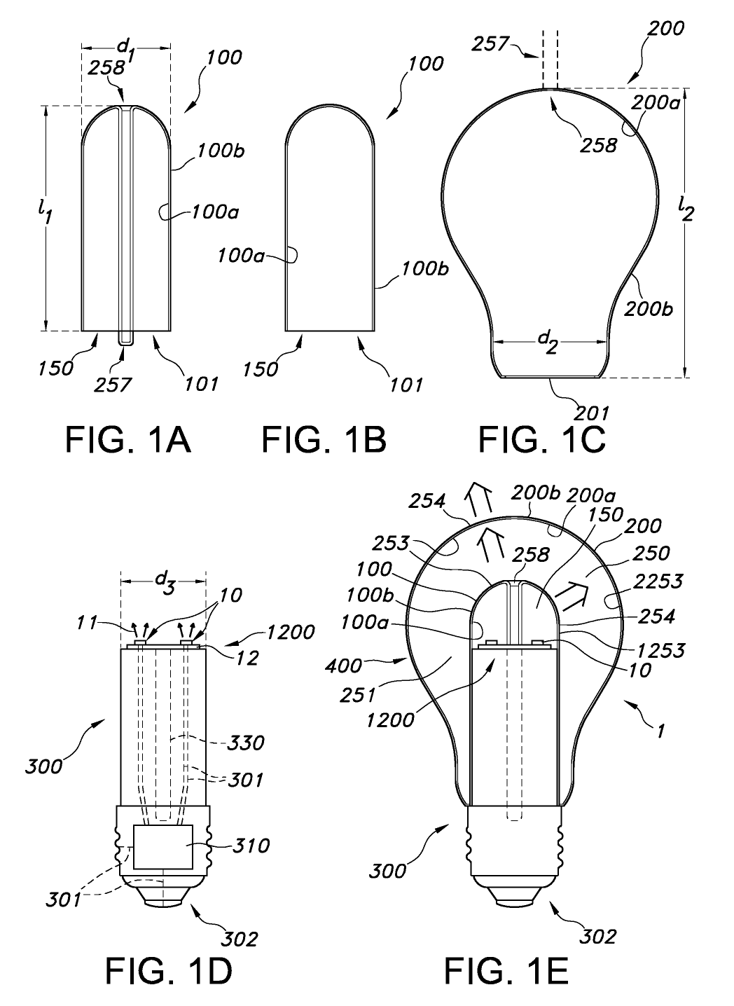

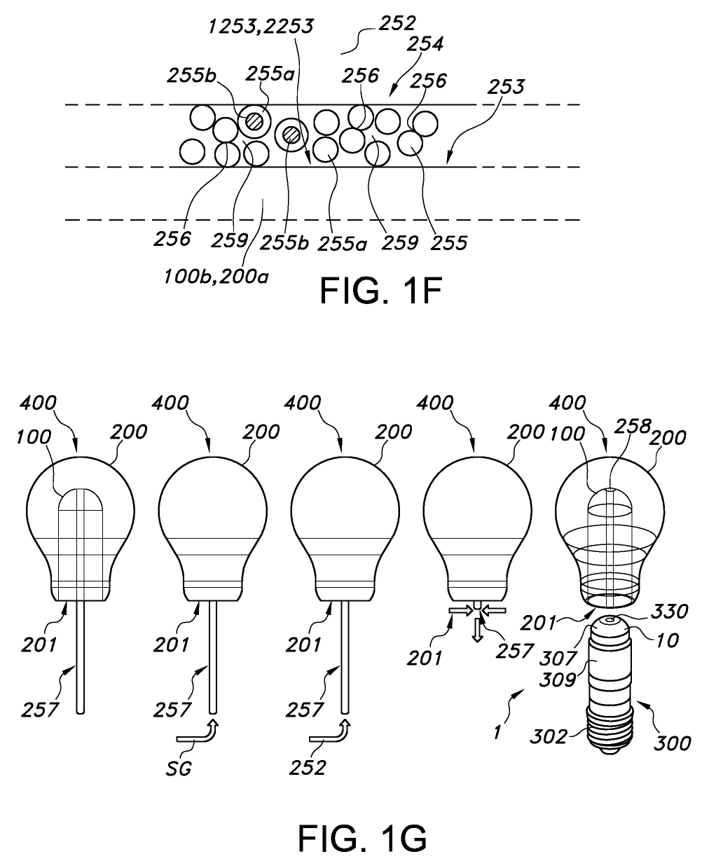

FIG. 1A-1E schematically depict several elements and options for assembling a lamp as defined herein. FIG. 1A schematically depicts a first envelope 100, having a cavity 150, and a larger envelope (or cavity) opening 101 (at one side), and an optional smaller opening, herein also indicated as second cavity opening 258 (at another side). In this embodiment, the pump stem, indicated with reference 257, is associated with this second cavity opening. Though this second cavity opening 258 is an opening in the first envelope, it gives access to the second cavity (see below).

FIG. 1B schematically shows an embodiment of the first envelope 100 without the second cavity opening 258 (and pump stem 257). The first envelope has an internal surface or upstream surface 100a, and an external surface or downstream surface 100b. In general, the first envelope 100 will include a part that is cylindrical, having a diameter d₁.

The length of the first envelope is indicated with reference l₁. The envelope has a first end comprising the cavity opening 101, and a second end, in general opposite of the first end, whereby the first end and the second end define the first envelope length L₁.

The schematic drawing 1C shows an embodiment of the second envelope 200. The second envelope has an internal surface or upstream surface 200a, and an external surface or downstream surface 200b. Often, also the second envelope 100 may include a cylindrical part having a diameter d₂. This cylindrical part may enclose the cylindrical part of the first envelope 100 (see below). The second envelope 200 includes an opening 201, through which part of the first envelope 100 may be arranged. The length of the second envelop is indicated with reference l₂. Note that by way of example the second envelope includes optionally a second cavity opening 258 with pump stem 257. FIG. 1D schematically depicts an embodiment of a power assembly 300. Here, the power assembly includes at least two light sources 10, configured on a support 1200, which also includes a heat sink 12. The light source 10 is configured to provide light 11, especially having a visible component. With dashed lines, electrical connections 301 are indicated, which are in electrical contact with an end cap 302, for instance an Edison cap. Reference 310 indicated by way of example electronics and/or a control unit, and may e.g. include a transformer and/or remote control elements. Reference 330 indicates a cavity for the pump stem remains. Note that the first envelope encloses the light source(s) 10 over angles of at least about 270°. The distance from the light source(s) 10 to the second end is substantially smaller than the distance to the first end, such as a distance ratio of the distance to the first end (with the opening 101) to the second end (well within the second envelope 200) of at least 1; here in this schematic embodiment (but also applicable to other embodiments, in the range of at least about 4.

For instance, one may combine the embodiments of FIGS. 1A and 1C (but especially without second cavity opening 258 and pump stem 257 of the embodiment of FIG. 1C), and power assembly 300 from FIG. 1D into the lamp 1 as schematically depicted in FIG. 1E. First the envelope assembly, indicated with reference 400 may assembled, then the wick layer, indicated with reference 254 may be provided to an internal cavity 250 or heat pipe 251, the desired working fluid 252 may be added and the right pressure conditions may be created, the pump stem may be closed, and then the power assembly 300 may be connected to the envelope assembly 400 (see also below). The heat pipe 251, i.e. the cavity 250 created by assembling the first envelope 100 and the second envelope 200 into the envelope assembly 400, has an internal surface 253, which includes at least part of the external surface 100b of the first envelope 100 and at least part (here substantially the entire) internal surface 200a of the second envelope 200. The (first) part of the first envelope that is covered with the wick layer 254 is indicated with reference 1253 and the (second) part of the second envelope that is covered with the wick layer 254 is indicated with reference 2253. Note that not the entire internal surface 23 of the heat pipe 251 has to be covered with the wick layer 254. The larger arrows indicate thermal energy flow. Further, the wick layer 254 may be provided before or after assembly of the envelope assembly 400.

FIG. 1F schematically depicts in more detail an embodiment of the wick layer 254 on e.g. the external surface 100b of the first envelope 100 or the internal surface 200a of the second envelope 200. For instance, particles 255 may be comprised by the layer, such as spherical particles. The particles may be hollow. The cavities, if any, within the particles may optionally be filled with particle filling material 255b. The material of the particles is indicated with reference 255a. Between the particles, there may be some binder material 256. In general, the binder material 256 amount may be relative low, to maintain the porosity. Pores are indicated with reference 259.

FIG. 1G schematically depicts how the lamp 1 can be made. First the envelope assembly 400 is provided by melting an inner tube or first envelope into the outer bulb or second envelope, e.g. similarly as a stem into a GLS bulb, or the inner tube of a QL lamp into the outer bulb. Then, a sol-gel (SG) can be pumped via the pump tube or pump stem 257 into the second envelope. Heating may occur to provide the porous wick layer. For instance, a small amount of liquid, such as water, is then pumped into the second envelope/cavity through the pump tube, which may be cooled to prevent evaporation when the air is pumped out of the second cavity. In the next stage, air may be pumped out of the second cavity and the pump stem is closed and cut off. By closing the pump stem 257, effectively the second cavity opening is (functionally) closed. There is (substantially) no gas communication between the second cavity and the external. After closing, the power assembly with light source may be inserted via the first opening 101 from the first cavity 100 and may be glued into this first envelope, thereby providing the lamp 1. Reference 307 indicates an optional protective cap and reference 309 indicates a closing means, for sealing of the first opening 101 of the first envelope. As indicated above, the wick layer 254 may be provided before or after (as described here) assembly of the envelope assembly 400.

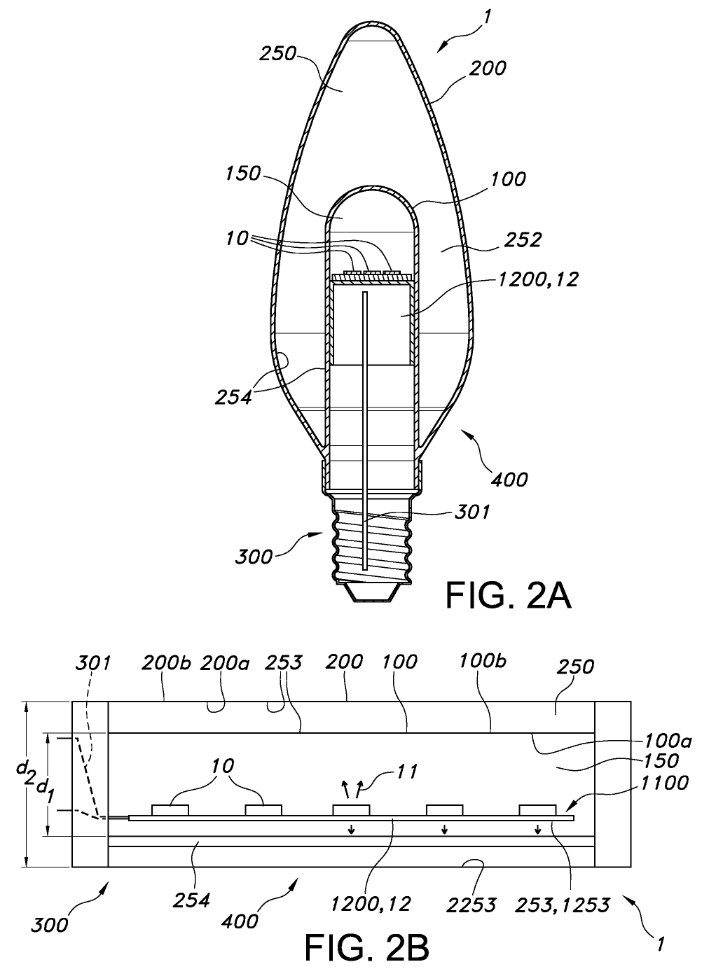

FIGS. 2A and 2B schematically depict some possible embodiments of the lamp 1, with FIG. 2A schematically depicting a retro shaped candle lamp 1, and FIG. 2B schematically depicting a tubular shape lamp 1. In the latter embodiment, both the first envelope 100 and the second envelope 200 are tubular shaped having substantial constant diameters (d₁ and d₂, respectively). At one (or more) positions light sources 10 may be arranged, for instance a light source array with an array of light sources 10. The light sources may be arranged closed to the internal face 100a of the first envelope 100, and especially in thermal contact therewith. Especially the external face 100b, adjacent to the light source(s) 10 may comprise the wick layer 254. Hence, part 1253 of the internal surface may be coated with the wick layer 254.

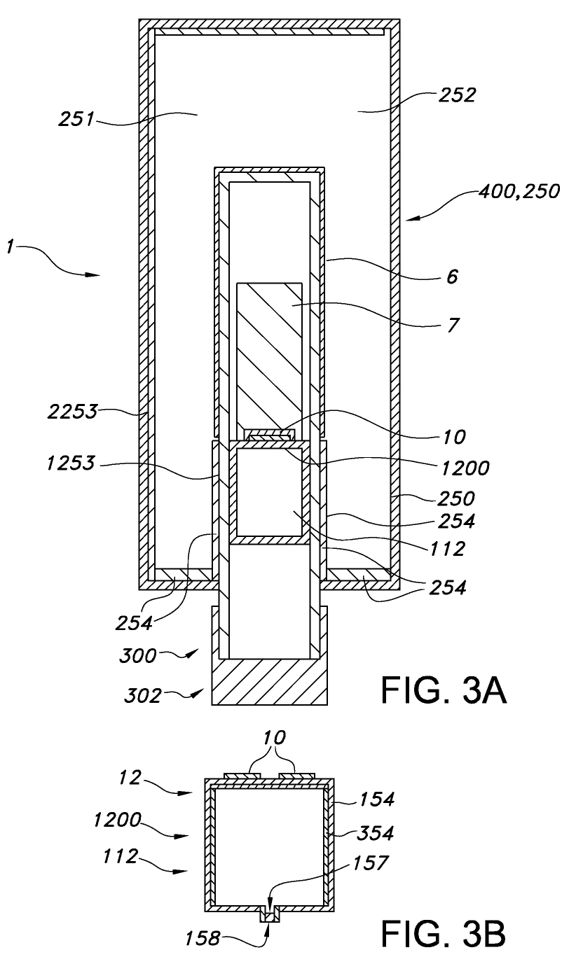

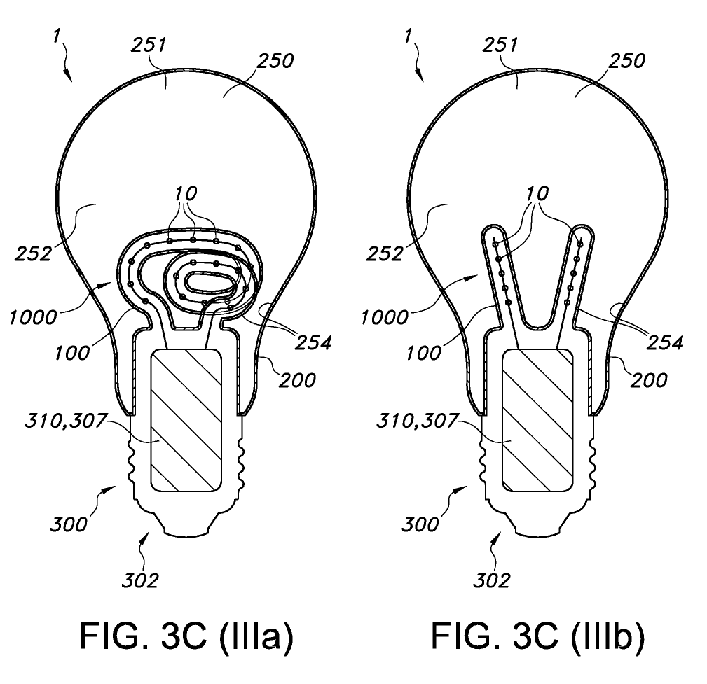

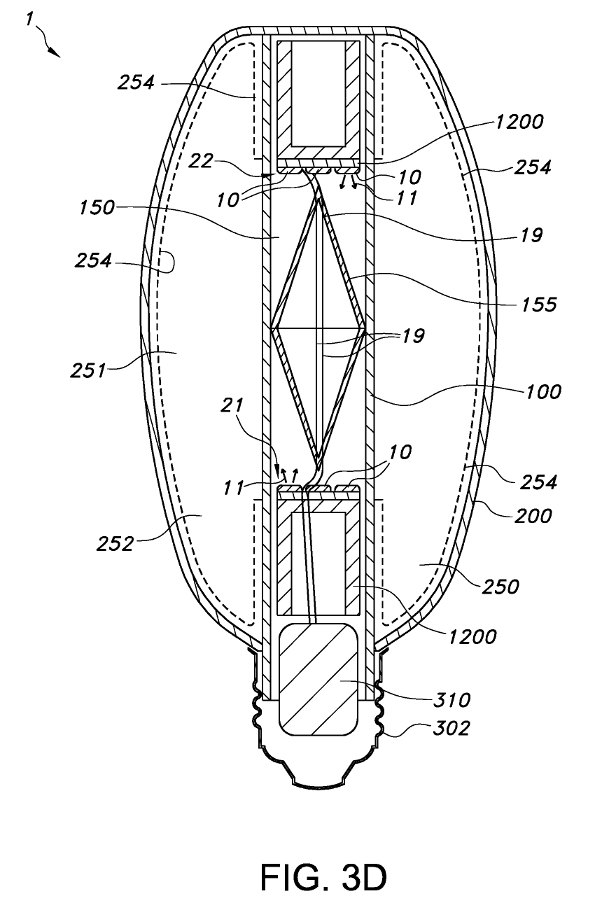

FIGS. 3A-3D schematically depict some variants of the lamp. Here, reference 6 indicates an optional optical coating, which may have the function of light scattering. Reference 7 indicates an optional collimator or light distributor. Here, the support 1200 includes also a heat pipe, which can in fact be used as heat sink 12. Here, the heat pipe is especially a ceramic heat pipe 112. The PCB may be integrated in the heat pipe and may also thus be ceramic. FIG. 3b schematically depicts the ceramic heat pipe 112 in more detail, with alumina walls 154 and a wick layer 354. FIGS. 3a and 3b may especially depict an embodiment of the lamp 1 wherein the first envelope 100 and the second envelope comprise a (transmissive) ceramic material. This embodiment thus comprises two heat pipes.

Further, this embodiment, but also other embodiments, may use the flat top of a ceramic heat pipe to mount the LEDs, while the side surface(s) is (are) used for heat transfer to a second two-phase cooling device made out of glass. The two contacting parts are co-axial, and preferably cylindrical. The thermal expansion coefficients of ceramics and glass can be matched. The whole assembly leads to a compact, light weight and thermally very effective LED cooling device. This embodiment may use a ceramic substrate for mounting LEDs, preferably round. Further, especially a ceramic (preferably cylindrical) heat pipe with flat outer end is applied. A wick structure and working fluid are available in the ceramic heat pipe 112. Especially, there may be a thermal interface material between ceramic heat pipe and glass vapor chamber. As indicated above, this is integrated in a lamp 1 with e.g. a glass vapor chamber or ceramic vapor chamber with inner (preferably cylindrical) wall and outer wall of any shape. Also in this vapor chamber or heat pipe 251 there is a wick structure and working fluid. Alternatively, the first and/or second envelope, especially at least both include a polymer. Further, optionally or addition, the first and/or the second envelope further comprises a coating to (further) prevent diffusion of gas like especially O₂ and/or N₂. For instance in case of a polymeric first and/or the second envelope a gas barrier coating may be desired.

The first and/or second envelope may optionally further comprise a coating, like porous PE (poly ethylene) as wick layer.

FIG. 3C schematically depicts two possible embodiments wherein the first cavity 150 comprises a tubular or helix light sources structure 1000 hosting a plurality of solid state light sources 10. The plurality of solid state light sources 10 may be provided in the form of a light source array with said plurality of light sources 10. Variant IIIa shows schematically a helix light source structure 1000, with the first envelope comprising this helical structure. Variant IIIb shows the first envelope having (by way of example) two tubular structures 1000, also with a light source array with said plurality of light sources 10. Reference 317 schematically depicts by way of example a driver.

In order to have effective cooling at the outer surface of the capillaries with a plurality of light sources, a capillary wick structure should be present that is interconnected with the wick that absorbs the condensed working fluid, in practice this can be the wick that is at the inside of the outer glass. In this way the cooling of the capillary is by evaporation, which is connected to an extremely high heat transfer coefficient that is sufficient to compensate for the low surface area. Optionally the internal surface of the second envelope has no wick layer but return of the liquid is by gravity, for which case the lamp can be used only standing upright or nearly upright (see also below).

The present invention also solves the problem that if packaged or soldered LEDs are used, they appear not to survive an oxygen-depleted sealed environment (such as a He only atmosphere).

Relevant aspects of this embodiment are for instance a high thermal resistances between LED filament and the interior gas and/or the prevention of oxygen depletion that appears to deteriorate packaged and soldered LEDs. Further, it solves the space problem when many LED strings may be required for e.g. 60 W or higher equivalent flux levels. Here, also a thermo-optical enclosure is provided, but now with one or more glass capillaries. The glass capillaries that do not have open ends in the interior of the glass container. Further, LED strings of filaments in the glass capillaries are provided. Optionally, transparent or translucent filling of the capillaries for heat transfer from the LED strings may be provided. Further, as also indicated above, a wick, translucent or transparent, fully or partially covering the glass capillary, optionally interconnected to the vapor chamber wick is provided. As indicated above, to have a better heat transfer from the LED string to the glass capillary wall, the capillaries can be (partially) filled up with a transparent material like silicone. The lamp 1 may e.g. be provided with a short internal cylinder containing a driver, with a single loop capillary with a LED-string and/or with a few single ended capillaries sticking into the vapor chamber. Especially, in case of base-down operation only, the wick structure at the inside of the outer glass envelope can be omitted, since the vapor chamber works gravity-assisted (thermo-siphon principle).

FIG. 3D schematically depicts an embodiment of the lamp 1 including at least two subsets 21,22 of solid state light sources 10 arranged within the first cavity 150.

Especially the first envelope 100 may be a cylindrical envelope. The subsets 21, 22 are especially facing each other. The first cavity 150 may further include an optical element 155 configured to direct the visible light 11 of the solid state light sources 10 of the at least two subsets 21,22 in a direction of the second envelope 250. Reference 19 indicates electrical wires. The optical element 155 may also include a plurality of optical elements. The optical element 150 may have refractive properties (for the light of the light sources 10).

For high flux applications the internal diameter of the glass pipe that also fits in the cap puts limits to the maximum light output. Further, the amount of heat that is generated on the PCB needs to be transferred to the vapor chamber via the heat spreader, the interface materials and the glass. An improved thermal performance leads to lower LED temperatures and allows more current through the LEDs. More parallel thermal paths from LEDs towards the vapor chamber reduce the thermal resistance. In the glass vapor chamber the working fluid condenses on the outer glass, and is transported back to the heat source by the wick. With bigger lamp sizes, the requirements to the wick increase strongly, since the pumping needs to be done over longer distances and in some orientations also against gravity. The proposed solution is to place two or more modules in the same cylindrical inner glass tube. The module comprises the LEDs, the PCB, the heat spreader and the thermal interface layers. Further, in the proposed solution the internal cylinder is connected to the outer glass at two sides, and at both sides the wick is continuous from cylinder to the outer envelope. The most interesting solution is to place 2 modules facing each other, each at one end of the inner cylinder. An optical module can be placed in between to divert the light sideways.

Here, a tubular internal glass compartment that is connected to the outer glass enclosure at two sides is provided. Further, especially the lamp 1 has an interior wick structure that is continuous from outer envelope to the internal glass wall. Further, two or more modules in the internal space of the thermo-optical enclosure may be provided. The module may each comprise LEDs, a PCB, a heat spreader and thermal interface materials. The heat spreaders can be heat pipes. Further, the PCB and heat spreader can be integrated in a ceramic PCB—heat pipe (see also above). Especially, there is an electrical connection of each module to the (single) driver. Further, an optional optical element to divert the light sideways may be available. Further, there may be a pumping stem stub on the vapor chamber (the pumping stem is pinched off during sealing).

A retrofit bulb with the integrated thermo-optical enclosure has been made with a transparent glass container as the outer enclosure. The outer shape of the container has a GLS A19 outline, the inner shape is cylindrical with a 21.4 mm internal diameter. The excellent thermal performance of this system that contained nothing but water was proven with a heater inserted in the inner cylindrical glass part while the outer enclosure was under normal lab ambient temperatures. Details of the preparation and the testing, including the test results follow below. After assembly of the glass parts, the glass container was cleaned thoroughly by heating in a 400° C. oven, after which an amount of about 10 ml of distilled water was injected through the pumping stem. The glass container was pumped to vacuum for several minutes during which some water was evaporated and was evacuated from the container. After pumping the pumping stem was sealed hermetically by local heating with a burner while running the pump. A heating element consisting of 2 thermal resistors mounted on a aluminum cylindrical block was inserted into the cylindrical part of the glass container. Some thermal paste was used to ensure good thermal contact between the aluminum heater and the glass. A thermocouple was glued on the aluminum to measure the temperature during the experiment. The aluminum part is expected to have a substantially uniform temperature in a steady state situation. The glass container was placed into a clamp with the glass pumping stem pointing downwards. The water level in the container was at the same height as the top of the aluminum heating block. In this set up no wick was used. The water level ensured the thermal contact of the working fluid with the heating element. In the thermal testing 8.5W of heat was dissipated in the thermal resistors. The lab ambient temperature was 24° C. In steady state the temperature of the aluminum block reached a temperature of 93° C. From this experiment the thermal resistance from aluminum to ambient expressed in K/W is Rth_alu_amb=8.1 K/W, which is a low value for a bulb of this size, compare Rth_base_amb=10 K/W for some current Philips LED bulbs. With an infrared camera the temperature of the outer glass part was measured. The outside glass has a very uniform temperature, as can only be expected from a vapour chamber. The measured average temperature is about 63° C. From the three measured temperatures one can derive an Rth outer-glass to amb of 4.6 K/W and a Rth_alu_to_outer-glass of 3.5 K/W. The thermal resistance from aluminum to the outer glass can still be improved by the dimensioning of the internal parts in the internal glass cylinder. In a second test the bulb was not evacuated, and ambient air was trapped after the sealing of the container. In the test with a similar heat load and similar ambient conditions the IR measured revealed a temperature gradient on the bulb enclosure. This indicates that the evaporation from the water surface is hindered by the air. The maximum temperature of the external enclosure in steady state is 77.3° C., which is 11° C. higher relative to ambient compared to the previous experiment with a maximum of 65.4° C. This indicates that the internal parts have a much higher temperature as well. In this orientation of the lamp there is no cold section on the outer wall of the enclosure. The water vapour has mixed well with the internal air and can condense on all parts. It is known that in different geometries, especially in tube like containers, the non-condensable gases are separated from the working fluid vapour and induce a cold section of the container.

In the following table the flux potential for bulbs is indicated assuming a LED solder temperature of 100° C. and an ambient of 25° C. The results are based on a detailed thermal model of the system. A system efficacy of 80 lm/W is assumed, which is typical for MP LED solutions in 2014. It is clear that with the smallest bulb size of 55 mm diameter more than 800 lumen (the equivalent of a 60 W GLS) can be generated, which can be considered best in class.

| | | | A60 IEC | A67 IEC |
|---|---|---|---|---|
| Type | | A55 | A19 ANSI | A21 ANSI |
| diam bulb | M | 0.055 | 0.060 | 0.067 |
| Rth_solder-amb | K/W | 9.5 | 8.5 | 7.0 |
| System efficacy | lm/W | 80 | 80 | 80 |
| flux max | Lm | 863 | 958 | 1164 |

The same concept can be expanded to much bigger, non-retrofit, sizes, opening up the possibility of very high flux levels in a lamp and similar system efficacies.

| Type | | Integrated Lamp-luminaire |
|---|---|---|
| diam bulb | m | 0.200 |
| Rth_solder-amb | K/W | 1.7 |
| System efficacy | lm/W | 80 |
| flux max | lm | 4870 |

| | | E40 lamp | Outdoor Lamp- |
|---|---|---|---|
| Type | | 10klumen | luminaire integrated |
| L × D | m × m | 0.3 × 0.08 | 0.4 × 0.2 |
| Rth_solder-amb | K/W | 1.4 | 0.7 |
| efficacy | lm/W | 100 | 100 |
| flux max | lm | 10159 | 20694 |

As the wick affects the light distribution it should not absorb the light. This excludes a lot of materials. Glass and ceramics like alumina, spinel and zirconia and diamond do not absorb visible light. Also some plastics like PMMA, PET, PC and poly-olefins are transparent or translucent, but care should be taken to minimize the outgassing of the plastics in a low pressure environment and/or permeating of a gas through the plastic (e.g. a gas barrier layer coating may be applied. Also glass or ceramics processing after application of the wick can lead to damage to the plastic wick materials. Because of the porous nature of the wick it will scatter the light. In almost all lighting applications with LED sources, some degree of light scattering is useful.

A low contact angle with the working fluid allows the fluid to be absorbed by the wick and develop a high capillary pressure. At least the contact angle should be <70°. For water a low contact angle means that the material is hydrophilic. With hydrophilic materials also other polar fluids like methanol, ethanol and acetone are expected to have a low contact angle. Water is known to have a very low contact angle on glass.

The capillary pressure of the wick enables pumping of the fluid, even against gravity, meaning that the fluid tends to get evenly distributed over the wick. Determining parameters for capillary pressure are the contact angle, the fluid surface tension and the (effective) pore size of the wick. The smaller the pore, the higher the capillary pressure. Typical pore sizes that are fit for this invention are between 1 and 100 micron. A way to reach these pores is by applying a sol-gel coating highly filled with glass or ceramic particles, specifically glass of sizes between land 150 micron are very effective for the wick. The solid phase in the sol-gel solution should be low enough to get a very open structure after evaporation of the solvent mainly defined by the glass particles.

The permeability for fluid flow increases strongly with the porosity and the effective pore size. Porosities of especially at least 30, such as at least 35% porosity, such as at least 40%, like especially ≧50% are herein desired values for wicks, and for the invention pore sized between 1 and 100 micron are applicable.

A sol-gel coating filled with particles like glass spheres could be applied from the fluid phase and could be an industrial viable process. A wick structure build from glass fibers, woven or non-woven is another viable solution. Also porous glass or ceramic fibers or hollow porous fibers may be applicable as wick. Woven or braided glass fiber sockets based on glass bundles containing standard 13 micron glass fibers have been tested to have good wicking properties.

Low cost wick material is a trivial prerequisite for a low cost solution. Glass particles, in particular glass spheres are available at low cost; also sol-gel is a low cost material.

Porous glass wicks have been prepared on flat glass using a sol-gel solution filled with glass spheres. The wicking properties of the coatings prepared by the sol-gel process with glass spheres were measured in a so-called capillary rate of rise experiment. Results are given in the table.

| Properties | | Sol-gel with glass beads |
|---|---|---|
| Particle type | | spherical |
| grain size d50 | μm | 50 |
| porosity | | 0.54 |
| P_capillary Pcap | kPa | 1.3 |
| Pore radius r_eff | μm | 110.8 |
| 1/r_eff | 1/μm | 0.009 |
| Permeability K | m² | 1.10E−11 |
| K * Pcap | N | 1.4E−08 |
| K/r_eff | μm | 0.099 |

The relevant properties and targets for the wick performance in different embodiments are coupled to the capillary limit of the wick. The capillary limit is related to the speed of fluid transport, characterized by K/r_eff, with K meaning the permeability for fluid flow and r_eff the effective pore size and the maximum capillary rise of liquid against gravity, characterised by 1/r_eff. For a coating of typically 0.3 mm thickness, the targets for wicks in A19 and A21 bulbs have been derived, leading to the targets 1/r_eff>0.01 μm and K/r_eff>0.1 μm. Both targets are satisfied with the sol-gel coating. In the above table, the value of 1.3 kPa for the capillary pressure Pcap indicates that the wick layer is able to rise water 13 cm (against gravity). These values are given as exemplary values, which may (even) further improve when optimizing lamps.

The coating should exhibit a high porosity such that both capillary pressure and transport properties are within the right operating range. Such a coating can be made by stacking particles of the right dimensions. From a processing point of view it is highly beneficial when this coating is entirely glass like in nature as this facilitates process-ability and assures low outgassing in the final product.

The coating basically exists of glass particles that are bonded together and to the envelope surface by a silicate-based binder. The binder is present in a concentration sufficient to assure adherence, while leaving the pores open. Typically glass particles are a few to 150 μm in size and are bonded by a methyl silicate that comprises about 1-20 vol-% of the final coating.

A solution of MTMS in an acidic water/alcohol mixture is made according to the following procedure.

### Composition of Sticky Layer Solution

5 gram Ludox AS40 (NH4) (colloidal silica dispersion)

1 gram MeOH (methanol)

4.5 gram methyltrimethoxysilane MTMS

1.5 ml Acetic acid (1.5 gr) (pH=˜2)

0.5 gram 2-ethoxy-ethylether (EEE)

This solution is applied to the envelope surface as a layer of about 2-10 μm in thickness. This can e.g. be done by e.g. spin-coating, spray-coating, flow-coating or dip-coating. A sticky layer results after annealing at 80° C. Glass spheres that preferably are in the range in size from 30 to 70 μm are subsequently brought into contact with this layer and adhere to this layer, thus resulting in a partly filled monolayer of spheres. By repeating this procedure thicker layers can be made. The final layer is annealed at elevated temperature (exceeding 400° C.) and/or exposed to oxygen plasma. This treatment results in the decomposition of methyl groups in the surface area, thus leading to a surface layer with relatively high surface free energy and therefore good wettability and a high capillary pressure.

The binder and the particles can also be applied in a single step. In that case a dispersion is used in which the particles are already dispersed in a solution of the binder precursor. Such a solution may have the following composition:

### Dispersion Composition

TEOS (tetra-ethoxysilane) 10.85 g

Water 2.3 g

1M HCl 1 g

Ethanol 20

Reaction takes place for 15 minutes under stirring at a temperature of about 40° C. Subsequently, 2-Propanole (60 g) is added. This solution is mixed with glass spheres (3M S60 (average diameter between 10-50 μm) in a weight ratio of 1 to 1. This solution can be applied in a single step with methods like e.g. spin-coating, spray-coating, flow-coating, dip-coating, blade-coating, tampon-printing or screen-printing. The layer thickness depends on the parameters of the coating technology and can further be tuned by composition and viscosity of the dispersion. As with method 1, it might be needed to improve the wetting properties of the surface by an additional treatment, like high-temperature annealing, oxygen plasma or UV/ozone treatment.

Under conditions were solubility of SiO₂ might become lifetime determining, less soluble binder material can be used.

Adding to the above mentioned TEOS based dispersion composition an aluminum salt results in the incorporation of aluminum in the binder material, which largely decreases the solubility as well as the dissolution rate. As an example, aluminum acetate and aluminum isopropoxide have been successfully added in an amount of 0.5 g to the TEOS dispersion. Alternatively, the tubes with wick coating based on a TEOS binder can also be impregnated with aluminum acetate solution. Upon subsequent annealing aluminum is incorporated in the binder, thus again reducing the binder solubility. Using aluminum acetate concentrations in the range of 0.007-0.035 g/cm³ resulted in lifetime extension by a factor of 4.

Example with TiO₂

Larger lifetime extension can be obtained by using less soluble oxides or nitrides as binder material. As an example, we used titanium oxide as binder material. The coating solution was either based on a TiO₂ sol (with TiO₂ particles in the order of a few tens of nm in diameter) or by using a hydrolysis mixture based on a titanium salt, like titanium acetylacetatonate or titanium isoproxide. Many variations are possible here. Some specific examples of dispersion compositions are listed here.

Starting material is a TiO₂ sol, either provided as 20 wt-% TiO₂ in 2-propanol or 15 wt-% TiO₂ in water. 15 wt-% titanium oxide (5-30 nm) in water (obtained from Nanostructured & Amorphous Materials Inc.) was diluted. This solution is diluted to obtain a solution with 0.5-5 wt-% TiO₂. Ti-isopropoxide precursor was dissolved in 2-proponal to obtain a concentration of 5-20 wt-% in 2-proponal. The dispersion composition thus obtained was either mixed with glass spheres (typically 10 g glass spheres was added to 20 g TiO₂ dispersion) or used to impregnate an already formed wick coating (without binder). Note that mentioned concentrations and ratios of binder to particles are not critical: the desired resulting layer thickness determines the required concentrations and is e.g. dependent on the diameter of the particles that are used for the wick coating.

As an additional advantage it should be noted that during the deposition process also the particles are coated by a thin layer of the titania, this method is therefore also interesting in case the solubility of the particles would limit product lifetime.

Many variations on these procedures can easily be envisaged. The glass particles can be replaced by particles of other transparent materials, the particle size can be varied, and instead of spherical the particles might irregularly shaped or have a rod-like or fiber-like shape. The binder material may also be chosen of a large group of material. In general sol-gel type materials will lead to the desired result. These materials can be pure silicates (e.g. derived from TEOS or water glass), might contain different organic groups (e.g. phenyl groups instead of methyl groups), can be made from transition metal oxide precursors, and can even be polymeric in nature (in that case the polymers should be hydrophilic or there surface region should be made hydrophilic by e.g. an oxygen plasma).

When applying a porous coating to glass surfaces that still need to be melted together, special measures can be taken to avoid that due to the glass melting process the porosity is locally interrupted. A straight-forward way is to locally apply relatively thick coatings to the parts to be connected, such that not the entire coating is affected by the melting process. An alternative is to apply a small amount of the coating dispersion after melting of the envelope parts, but before filling the envelope with the two-phase working fluid. Alternatively, during the melting process the parts of the envelope close to the connection between inner and our envelope can be deformed, such that the coatings on both surfaces in that area touch each other over a range from 1 mm to 1 cm. This will guarantee continuous porosity over the entire inner surface area of the final envelope.

1. A lamp comprising:
a solid state light source and a first envelope at least partially enclosing the solid state light source, thereby forming a first cavity hosting said solid state light source, wherein at least part of the first envelope is transmissive for visible light generated by the solid state light source;
a second envelope at least partially enclosing the first envelope, wherein the first envelope and the second envelope provide a second cavity at least partially enclosing the solid state light source, wherein at least part of the second envelope is transmissive for visible light generated by the solid state light source and transmitted through the first envelope into the second cavity, wherein the second cavity is configured as a heat pipe comprising a heat pipe working fluid and comprising over at least part of an internal surface of said second cavity a heat pipe wick layer, wherein at least a part of the internal surface of said second cavity formed by the first envelope comprises said heat pipe wick layer, wherein said heat pipe wick layer comprises a coating;
a power assembly comprising said solid state light source, a component configured to transfer electrical power from an external source to the solid state light source, and an end cap, wherein the first cavity at least partly hosts the power assembly.

2. The lamp according to claim 1, wherein the heat pipe wick layer comprises a sol-gel coating, and wherein said heat pipe wick layer comprises particles having dimensions selected from the range of 1-150 μm.

3. The lamp according to claim 1, wherein the heat pipe wick layer is obtainable by a method comprising a wet chemical deposition coating process via a pump stem functionally coupled with the second cavity.

4. The lamp according to claim 1, further comprising a solid state light source support in thermal contact with the first envelope, wherein the solid state light source support includes a heat sink, and wherein the heat sink is in physical contact with the first envelope.

5. The lamp according to claim 4, wherein the solid state light source support includes a heat sink, wherein the heat sink comprises a ceramic heat pipe.

6. The lamp according to claim 1, wherein at least a part of the internal surface of said second cavity formed by the second envelope also comprises said heat pipe wick layer.

7. The lamp according to claim 1, wherein said heat pipe wick layer is transmissive for visible light generated by the solid date light source unit, and wherein said heat pipe wick layer comprises particles having dimensions selected from the range of 1-150 μm, and wherein the particles comprise a particle material transmissive for visible light generated by the solid state light source unit.

8. The lamp according to claim 1, wherein said heat pipe wick layer comprises particles comprising a particle material transmissive for visible light generated by the solid date light source unit, wherein said heat pipe wick layer further comprises a binder material, and wherein the heat pipe wick layer is obtainable by one or more of flow coating and dip coating.

9. The lamp according to claim 1, wherein one or more of the first envelope and the second envelope comprise a material independently selected from the group consisting of glass, a translucent ceramic, and a light transmissive polymer, and wherein the second envelope has the shape of a bulb lamp, a candle lamp, or a tubular lamp, and wherein the heat pipe working fluid comprises one or more of H₂O, methanol, ethanol, propanol, butanol, acetone, pentane, heptane, and ammonia.

10. The lamp according to claim 1, wherein the power assembly comprises an assembly cavity for hosting a pump stem functionally coupled with the second cavity, and the first envelope including a cylindrical part, having a diameter which is constant over at least part of the length of the first envelope.

11. The lamp according to claim 1, wherein the first cavity comprises a tubular or helix light sources structure hosting a plurality of solid state light sources.

12. The lamp according to claim 1, including at least two subsets of solid state light sources arranged within the first cavity and facing each other, wherein the first cavity further includes an optical element configured to direct the visible light of the solid state light source of the at least two subsets in a direction of the second envelope.

13. An envelope assembly comprising:
a first envelope, configured to enclose at least partially a solid state light source, wherein at least part of the first envelope is transmissive for visible light;
a second envelope at least partially enclosing the first envelope, wherein the first envelope and the second envelope provide a second cavity, the closed cavity configured to enclose at least partially said solid state light source, wherein at least part of the second envelope is transmissive for visible light, wherein the second cavity is configured as a heat pipe comprising a heat pipe working fluid and comprising over at least part of an internal surface of said second cavity heat pipe wick layer wherein at least a part of the internal surface of said second cavity formed by the first envelope comprises said heat pipe wick layer, wherein said heat pipe wick layer comprises a coating, and wherein the envelope assembly further comprises a pump stem functionally coupled with the second cavity.

14. A power assembly comprising a solid state light source, a component configured to transfer electrical power from an external source to the solid state light source, and an end cap, wherein the power assembly comprises an assembly cavity for hosting a pump stem.

15. A power assembly according to claim 14 at least partly in the first cavity of the envelope assembly and securing the power assembly and the envelope assembly to each other, wherein the envelope assembly is obtainable by a method comprising: providing the second cavity by connecting the first envelope and the second envelope, providing a heat pipe working fluid to the second cavity; and closing the second cavity, wherein the heat pipe wick layer is provided to the one or more of at least part of the external surface of the first envelope and at least part of the internal surface of the second envelope before assembly of the envelope assembly or after assembly of the envelope assembly.

16. The method according to claim 15, wherein the heat pipe wick layer is obtainable by a method comprising a sol-gel coating process via a pump stem functionally coupled with the second cavity using a sol-gel composition, and wherein the sol-gel composition comprising particles, especially spherical particles, even more especially having dimensions, such as diameters, selected from the range of 1-150 μm.
